(19) United States
(12) Patent Application Publication
(10) Pub. No.: US 2026/0205040 A1
(43) Pub. Date: Jul. 16, 2026

(54) MOTOR CONTROL DEVICE

(71) Applicant: FANUC CORPORATION, Minamitsuru-gun, Yamanashi (JP)

(72) Inventors: Ryou MORIHASHI, Yamanashi (JP); Shougo SHINODA, Yamanashi (JP)

(21) Appl. No.: 19/137,106

(22) PCT Filed: Jan. 27, 2023
(86) PCT No.: PCT/JP2023/002653

§ 371 Date: Jun. 9, 2025

(51) Int. Cl. H02P 23/00; H02P 23/14; H02P 23/30

(52) U.S. Cl. CPC H02P 23/0004; H02P 23/14; H02P 23/30

(57) ABSTRACT

A motor control device comprises a motor control unit that controls a motor, a signal input unit that inputs a command signal to the motor control unit, an input/output response calculation unit that calculates an input/output response including the gain of an input/output signal of the motor control unit from the output from the motor control unit when the command signal is inputted to the motor control unit, an input/output response storage unit that stores the calculated input/output response, a condition-setting unit that sets conditions for assessing whether the characteristics of the command signal are to be changed, a comparison unit that compares the calculated input/output response with the stored input/output response, and a signal-changing unit that changes the characteristics of the command signal in cases where the result of comparison by the comparison unit does not satisfy the conditions set by the condition-setting unit.

### TECHNICAL FIELD

The present disclosure relates to a motor control device, and, in particular, relates to a motor control device that inputs a command signal to a motor control unit that controls a motor, calculates an input/output response including a gain of an input/output signal of the motor control unit, and uses the input/output response to change characteristics of the Command signal to adjust the characteristics of the command signal.

### BACKGROUND ART

When a gain or a filter is to be adjusted in a motor control device, a frequency response is measured, and parameters for the gain or the filter are changed based on a result of the measurement.

Patent Document 1 describes a servo motor control device providing a comprehensive inspection technique for not only simply stabilizing a servo control system, but also making it possible to achieve prediction of maintenance and inspection for a machine in a non-destructive and non-disassembly manner. Specifically, Patent Document 1 describes that the servo motor control device includes: a speed command creation unit that creates a speed command value for a servo motor; a speed detection unit that detects a speed of the servo motor; a torque command creation unit that creates a torque command value for the servo motor; a sine wave generation unit that generates a sine wave disturbance value; a frequency response calculation unit that calculates a frequency response when the sine wave disturbance value is inputted to a speed control loop; a resonance frequency detection unit that detects a resonance frequency at which a gain of the frequency response becomes maximum; a resonance frequency storage unit that stores the resonance frequency; at least one filter that attenuates a certain frequency band component included in the torque command value; and a resonance frequency comparison unit that measures rigidity of a machine tool based on the resonance frequency, and adjusts the filter with respect to the resonance frequency.

Patent Document 2 describes a servo control device that displays an adjustment state by an automatic adjustment sequencer and reasons of interruption or abnormal end during adjustment to make it possible to achieve safer automatic adjustment. Specifically, Patent Document 2 describes that the servo control device includes: a speed command creation unit; a torque command creation unit; a speed detection unit; a speed control loop; a speed control loop gain setting unit; at least one filter that removes a certain band in a torque command value; a sine wave disturbance input unit that sweeps a sine wave for a speed control loop; a frequency characteristics calculation unit that estimates a gain and a phase of a speed control loop input/output signal; a resonance frequency detection unit; a filter adjustment unit that adjusts the filter in accordance with a resonance frequency; a gain adjustment unit; a sequence control unit that automatically performs in an on-line manner detection of a resonance frequency, adjustment of a speed control loop gain, and adjustment of the filter; and an adjustment state display unit, in which the adjustment state display unit displays an adjustment stage and a progress situation of the sequence control unit.

### CITATION LIST

### Patent Document

Patent Document 1: Japanese Unexamined Patent Application, Publication No. 2016-34224
Patent Document 2: Japanese Unexamined Patent Application, Publication No. 2017-22855

### DISCLOSURE OF THE INVENTION

### Problems to Be Solved by the Invention

Providing a torque command having a sine wave form to the servo control device makes it possible to calculate a frequency response from the torque command and feedback (FB) from the servo control device. However, when a cycle of changing a frequency of a torque command having a sine wave form, which is to be provided, is small (when a number of times of signals for torque commands providing the frequency is small) or when torque is small, a correct frequency response may not be acquired. Although, in a case of manual adjustment, it is possible to take measures while a magnitude (an amplitude) of torque or a cycle is determined from a machine configuration or a result of measurement, adjustments are performed, measurements are performed, and operation is confirmed, taking such measures is difficult in a case of automatic adjustment.

Therefore, a motor control device making it possible to determine characteristics of a command signal such as a torque command through automatic adjustment has been demanded.

### Means for Solving the Problems

A representation aspect of the present disclosure is a motor control device including: a motor control unit that controls a motor; a signal input unit that inputs a command signal to the motor control unit; an input/output response calculation unit that calculates an input/output response including a gain of an input/output signal of the motor control unit from an output from the motor control unit when the command signal is inputted to the motor control unit; an input/output response storage unit that stores the input/output response calculated by the input/output response calculation unit; a condition-setting unit that sets conditions for determining whether or not characteristics of the command signal are to be changed; a comparison unit that compares the input/output response calculated by the input/output response calculation unit with the input/output response stored in the input/output response storage unit; and a signal-changing unit that changes the characteristics of the command signal when a result of the comparison by the comparison unit does not satisfy the conditions set by the condition-setting unit.

### BRIEF DESCRIPTION OF THE DRAWINGS

FIG. 1 is a block diagram illustrating a configuration of a motor control device according to an embodiment of the present disclosure.

FIG. 2 is a block diagram illustrating a configuration example of a motor control unit included in the motor control device.

FIG. 3 is a diagram illustrating frequency characteristics of an input/output gain and frequency characteristics of a phase when a cycle of changing a frequency is changed from a small cycle to a large cycle.

FIG. 4 is a diagram illustrating a change of torque when a frequency is changed in a small cycle.

FIG. 5 is a diagram illustrating a change of torque when a frequency is changed in a large cycle.

FIG. 6 is a diagram illustrating the frequency characteristics of an input/output gain and the frequency characteristics of a phase when an amplitude of torque is changed from a small amplitude to a large amplitude.

FIG. 7 is a flowchart illustrating adjustment operation for a cycle in the motor control device.

FIG. 8 is a block diagram illustrating a configuration of a motor control unit according to a modification example.

### PREFERRED MODE FOR CARRYING OUT THE INVENTION

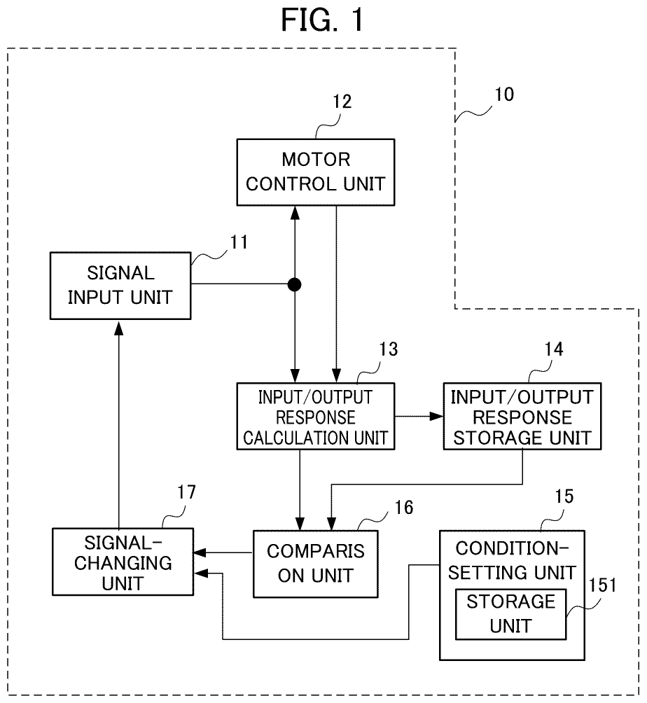

An embodiment of the present disclosure will now be described herein in detail with reference to the accompanying drawings. FIG. 1 is a block diagram illustrating a configuration of a motor control device according to an embodiment of the present disclosure. A motor control device 10 includes, as illustrated in FIG. 1, a signal input unit 11, a motor control unit 12, an input/output response calculation unit 13, an input/output response storage unit 14, a condition-setting unit 15, a comparison unit 16, and a signal-changing unit 17.

The signal input unit 11 inputs a command signal for controlling the motor control unit 12 to the motor control unit 12. A command signal inputted to the motor control unit 12 is, for example, an excitation signal having a sine wave, cosine wave, or rectangular wave form, an impulse signal, an M-sequence signal, or a step signal. A command signal is, for example, a signal that increases linearly, logarithmically, or exponentially.

The motor control unit 12 generates a speed command based on a position command outputted from a computer numeric control (CNC) machine, for example, generates a torque command based on a value acquired by adding the speed command and the command signal outputted from the signal input unit 11 to each other, and controls a motor 20 described later based on the torque command. Furthermore, the motor control unit 12 outputs the torque command to the input/output response calculation unit 13.

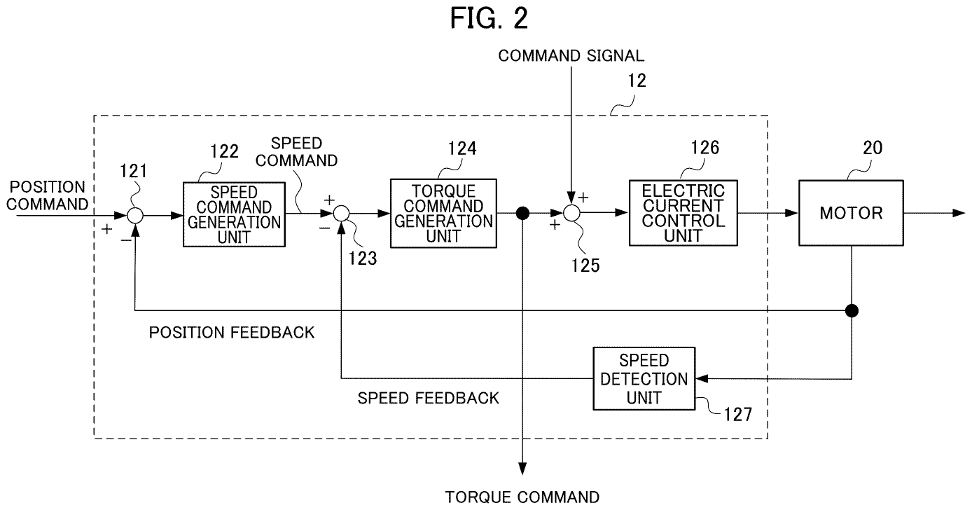

An example of a configuration of the motor control unit 12 will now be described herein with reference to FIG. 2. FIG. 2 is a block diagram illustrating a configuration example of the motor control unit. As illustrated in FIG. 2, a subtracter 121, a speed command generation unit 122, a subtracter 123, a torque command generation unit 124, an adder 125, an electric current control unit 126, and a speed detection unit 127 are included.

The subtracter 121 acquires a difference between a position command outputted from the CNC machine, for example, and a detection position serving as position feedback, and outputs the acquired difference to the speed command generation unit 122 as a positional error.

The speed command generation unit 122 outputs a value acquired by multiplying the position command outputted from the CNC machine, for example, by a position gain Kp that is set beforehand to the subtracter 123 as a speed command. The subtracter 123 acquires a difference between the speed command and a detection speed serving as speed feedback, and outputs the acquired difference to the torque command generation unit 124 as a speed error.

The torque command generation unit 124 adds a value acquired by multiplying the speed command by an integration gain K1v for integration and a value acquired by multiplying the speed command by a proportional gain K2v to each other, and outputs the acquired value to the adder 125 and the input/output response calculation unit 13 as a torque command.

The adder 125 adds the torque command and the command signal to each other, and outputs the torque command added with the command signal to the electric current control unit 126.

The electric current control unit 126 generates an electric current command for driving the motor 20 based on the torque command added with the command signal, and outputs the electric current command to the motor 20. A target to be driven by the motor 20 is, for example, a mechanical part of a machine tool, a robot, or an industrial machine. The motor 20 may be provided as a part of a machine tool, a robot, or an industrial machine, for example.

A rotation angle position of the motor 20 is detected by a rotary encoder (not illustrated) provided to the motor 20, and a position detection value (detection position) is outputted to the subtracter 121 as position feedback. The position detection value is converted by the speed detection unit 127 into a speed, and a speed detection value (detection speed) is inputted to the subtracter 123 as speed feedback.

The input/output response calculation unit 13 uses the command signal and the torque command to calculate an input/output response. The torque command is an output from the motor control unit 12. An input/output response represents, for example, frequency characteristics of an input/output gain and a phase or time response characteristics of an input/output gain and a phase. An input/output gain is a gain of an input/output signal.

Although, in the present embodiment, the input/output response calculation unit 13 acquires an input/output response in a feedback loop (for position feedback and speed feedback) including the motor control unit 12 and the motor 20, no feedback loop may be configured when an input/output response is to be calculated.

The input/output response storage unit 14 stores the input/output response calculated by the input/output response calculation unit 13.

The condition-setting unit 15 sets conditions for determination in the signal-changing unit 17. The conditions are conditions for allowing the signal-changing unit 17 to determine whether or not characteristics of a command signal are to be changed. The characteristics of a command signal include, for example, a cycle of changing a frequency of the command signal or an amplitude of the command signal. The conditions are stored in the storage unit 151.

The conditions are, for example, conditions related to a frequency movement of resonance between two input/output responses calculated by the input/output response calculation unit 13 before and after the characteristics of a command signal have been changed by the signal-changing unit 17. The conditions related to a frequency movement of resonance include, for example, a fact that resonance of the input/output response calculated by the input/output response calculation unit 13 has not yet moved from resonance of an input/output response before a command signal stored in the input/output response storage unit 14 has been changed or a fact that a frequency to which resonance of the input/output response calculated by the input/output response calculation unit 13 has moved from resonance of an input/output response before the command signal stored in the input/output response storage unit 14 has been changed is equal to or below a value set beforehand. A resonance movement amount is a frequency movement amount of resonance between two input/output responses calculated by the input/output response calculation unit 13 before and after the characteristics of a command signal have been changed by the signal-changing unit 17. A resonance movement amount serving as a condition will be hereinafter referred to as a resonance movement amount RM2. When no resonance movement occurs, the resonance movement amount RM2 becomes 0. The resonance movement amount RM2 is, for example, set beforehand before shipping or inputted by a user via a keyboard.

The condition-setting unit 15 has caused the storage unit 151 to store conditions for frequency movement amounts of resonance for determining whether or not the characteristics of a command signal, which are to be used in the signal-changing unit 17 described later, are to be changed. Furthermore, the condition-setting unit 15 has caused the storage unit 151 to store conditions for other than the frequency movement amounts of resonance. For example, the condition-setting unit 15 has caused the storage unit 151 to store conditions including a constant value or a constant magnification for changing the characteristics of a command signal, which are to be used in the signal-changing unit 17 described later, and a set value for an average value or a maximum value of an input/output response or a set value for an average value or a maximum value of a speed detection value. Furthermore, the condition-setting unit 15 has caused the storage unit 151 to store conditions including, for example, a set value for at least one of an input/output response, a speed, torque, and abnormal noise, which is to be used in the signal-changing unit 17 described later. Conditions for frequency movement amounts and set values as described above, for example, may be inputted by the user via the keyboard and stored, but may be embedded in a machining program such as G code and read and stored. Furthermore, the condition-setting unit 15 may designate, when the amplitude of a command signal is to be increased, a value equal to rated electric current torque as a set value, and may cause the storage unit 151 to store a condition of equal to or below the set value.

The comparison unit 16 compares the input/output response calculated by the input/output response calculation unit 13 with the input/output response stored in the input/output response storage unit 14, and outputs a result of the comparison to the signal-changing unit 17. A result of the comparison is, for example, a resonance movement amount RM1 between the input/output response calculated by the input/output response calculation unit 13 and the input/output response stored in the input/output response storage unit 14.

The cycle of changing the frequency of a command signal (hereinafter referred to as the cycle) or the amplitude of a command signal changes in a step-wise manner as an instruction is provided from the signal-changing unit 17. The input/output response calculated by the input/output response calculation unit 13 is the input/output response after the cycle or amplitude has been changed, and the input/output response stored in the input/output response storage unit 14 is the input/output response before the cycle or amplitude has been changed.

The signal-changing unit 17 changes the characteristics of a command signal when the result of the comparison by the comparison unit 16 does not satisfy the conditions set by the condition-setting unit 15, and determines the characteristics of a command signal when the result satisfies the conditions set by the condition-setting unit 15. For example, the signal-changing unit 17 operates as described below. The signal-changing unit 17 compares the resonance movement amount RM1 outputted from the comparison unit 16 with the resonance movement amount RM2 set by the condition-setting unit 15 and, when the resonance movement amount RM1 is larger than the resonance movement amount RM2, instructs the signal input unit 11 to increase the cycle or amplitude of a command signal. An increment width for the cycle or amplitude of a command signal may be represented by a constant value, or may be set based on the resonance movement amount RM1. The signal-changing unit 17 determines the cycle or amplitude of a command signal of the signal input unit 11 when the resonance movement amount RM1 is 0 or equal to or below the resonance movement amount RM2. The signal-changing unit 17 may instruct, when the resonance movement amount RM1 is equal to or below the resonance movement amount RM2, the signal input unit 11 to further change the cycle or amplitude of a command signal to acquire an optimum value of the cycle or amplitude of a command signal. When the cycle or amplitude of a command signal has been changed, and when the resonance movement amount RM1 has become larger than that before the cycle or amplitude of a command signal has been changed, the cycle or amplitude of the command signal before being changed is designated as an optimum value.

The signal-changing unit 17 is able to perform processing described below using the set value for at least one of an input/output response, a speed, torque, and abnormal noise, which has been stored in the storage unit 151 in the condition-setting unit 15. That is, the signal-changing unit 17 is able to, when the cycle or amplitude of a command signal is to be changed, and when a maximum value of the input/output response calculated by the input/output response calculation unit 13 based on the changed command signal is equal to or above the stored set value for an input/output response, return the command signal to the value before changing, decrease the increment width for the characteristics of the command signal, and change the command signal again.

Furthermore, the signal-changing unit 17 is able to, when the cycle or amplitude of a command signal is to be changed, and when the speed or torque of the motor 20 is equal to or above the stored set value for the speed or torque, return the command signal to the value before changing, decrease the change width for the characteristics of the command signal, and change the command signal again. It is possible to acquire the speed of the motor 20 from a detection position detected by the rotary encoder (not illustrated) provided to the motor 20, and it is possible to detect the torque of the motor 20 by a torque sensor provided to the motor 20. It is also possible to acquire the torque of the motor 20 by detecting an electric current for the motor 20 and multiplying the detected electric current by a torque constant.

Furthermore, the signal-changing unit 17 is able to, when the cycle or amplitude of a command signal is to be changed, acquire noise from a noise level meter and, when the acquired noise is equal to or above the set value, return the command signal to the value before changing, decrease the increment width for the characteristics of the command signal, and change the command signal again.

In addition, the signal-changing unit 17 is able to, when the amplitude of a command signal is to be changed, designate a value equal to rated electric current torque as a set value and, when the amplitude is equal to or above the set value, return the command signal to the value before changing, decrease the increment width for the characteristics of a command signal, and change the command signal again.

Even when the signal-changing unit 17 has set the increment width for the characteristics of a command signal to minimum, at least one of an input/output response, a speed, torque, abnormal noise, and the amplitude of a command signal may exceed a set value. In that case, the signal-changing unit 17 is able to, even when a resonance movement amount does not satisfy the conditions, determine the cycle or amplitude of a command signal of the signal input unit 11.

The signal-changing unit 17 is able to change the characteristics of a command signal by a set constant value or a set constant magnification or change a value or a ratio of a change width as the characteristics of a command signal change. For example, when the amplitude of a command signal is small, it is possible to apply a change at a large ratio, and, when the amplitude is large, it is possible to apply a change at a small ratio. The signal-changing unit 17 may not set the change width by a constant value or a constant magnification, but may determine the change width at the ratio for the previous change width. A set value for a constant value or a constant magnification is stored in the storage unit 151 in the condition-setting unit 15, and is outputted by the condition-setting unit 15 to the signal-changing unit.

The signal-changing unit 17 may determine whether or not the change width for a command signal is to be changed by a set value or at a set ratio based on whether or not at least either an average value or a maximum value of the input/output response calculated by the input/output response calculation unit 13 exceeds a set value. A set value is stored in the storage unit 151 in the condition-setting unit 15, and is outputted by the condition-setting unit 15 to the signal-changing unit.

The signal-changing unit 17 may determine whether or not the change width for a command signal is to be changed by a set value or at a set ratio based on whether or not at least either an average value or a maximum value of a speed detection value of the motor control unit 12 exceeds a set value. A set value is stored in the storage unit 151 in the condition-setting unit 15, and is outputted by the condition-setting unit 15 to the signal-changing unit.

The signal-changing unit 17 causes, when a result of the comparison by the comparison unit 16 is determined to not satisfy the conditions set by the condition-setting unit 15 while the signal input unit 11 is inputting a command signal, the signal input unit to stop inputting of the command signal in progress, and changes the characteristics of the command signal.

An example of the frequency characteristics of an input/output gain and the frequency characteristics of a phase, which are calculated by the input/output response calculation unit 13 when the signal-changing unit 17 has changed the cycle of a command signal, will now be described herein.

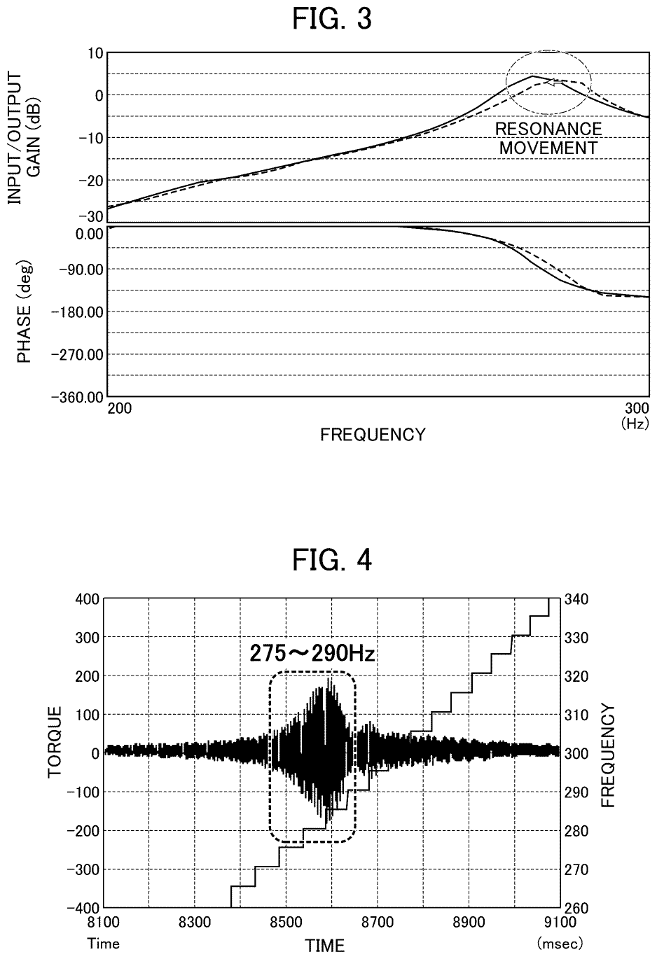

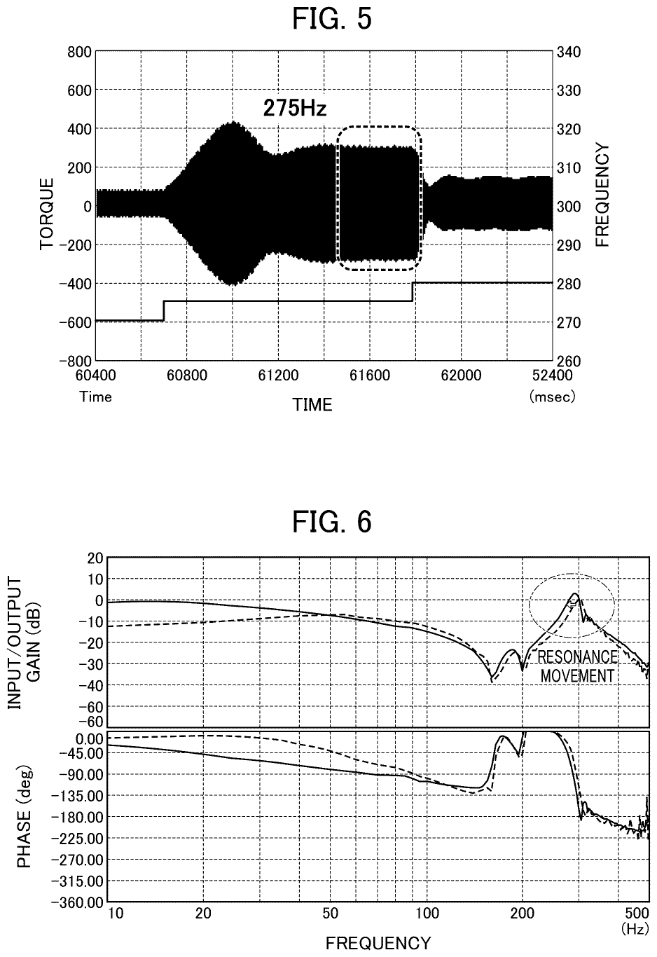

FIG. 3 is a diagram illustrating the frequency characteristics of an input/output gain and the frequency characteristics of a phase when the cycle of changing the frequency is changed from a small cycle to a large cycle. FIG. 4 is a diagram illustrating a change of torque when the frequency is changed in a small cycle. FIG. 5 is a diagram illustrating a change of torque when the frequency is changed in a large cycle.

The signal-changing unit 17 is able to, when the cycle of a command signal is to be changed, first start with and decrease a larger cycle in a step-wise manner, but may preferably first start with and increase a smaller cycle in a step-wise manner. Its reasons are as described below. As illustrated in FIG. 3, when a small cycle is changed to a large cycle, a resonance movement to a lower frequency occurs.

When the cycle is small, a transition to a next frequency occurs before a torque value reaches a constant state in a section (as illustrated by a rectangular broken-line frame in the drawing) where the frequency increases by 5 Hz in a step-wise manner from 275 Hz to 290 Hz, as illustrated in FIG. 4, for example, and fluctuation of the torque value, which has occurred in the previous frequency, remains in the next frequency, making it difficult to allow the comparison unit 16 to correctly determine a resonance movement. When the cycle is large, a transition to a next frequency (280 Hz) occurs after, in a range of 275 Hz, a torque value reaches a constant state (as illustrated by a rectangular broken-line frame in the drawing), as illustrated in FIG. 5, for example, on the other hand, a difference in fluctuation of the torque value between the previous frequency and the next frequency becomes clear, making it possible to allow the comparison unit 16 to correctly determine a resonance movement.

However, when the signal-changing unit 17 enters in an early stage a large cycle of a command signal, excitation occurs for a long period of time due to resonance, resulting in a risk of oscillation. Therefore, the signal-changing unit 17 may preferably first start with and increase a smaller amplitude in a step-wise manner when the cycle of a command signal is to be changed.

Next, an example of the frequency characteristics of an input/output gain and the frequency characteristics of a phase, which are calculated by the input/output response calculation unit 13 when the signal-changing unit 17 has changed the amplitude of a command signal, will now be described herein. FIG. 6 is a diagram illustrating the frequency characteristics of an input/output gain and the frequency characteristics of a phase when the amplitude of torque is changed from a small amplitude to a large amplitude.

The signal-changing unit 17 may also preferably first start with and increase a smaller amplitude in a step-wise manner when the amplitude of a command signal is to be changed, similar to the case when the cycle of a command signal is to be changed. Its reasons are as described below. As illustrated in FIG. 6, when a small amplitude is changed to a large amplitude, a resonance movement to a low frequency occurs. When the amplitude is small, the comparison unit 16 faces difficulties in correctly determining a resonance movement. When the amplitude is large, on the other hand, a correct position of resonance becomes clear, allowing the comparison unit 16 to correctly determine a resonance movement.

However, when the signal-changing unit 17 enters in an early stage a large amplitude of a command signal, excitation occurs for a long period of time due to resonance, resulting in a risk of oscillation. Therefore, the signal-changing unit 17 may preferably first start with and increase a smaller amplitude in a step-wise manner when the amplitude of a command signal is to be changed.

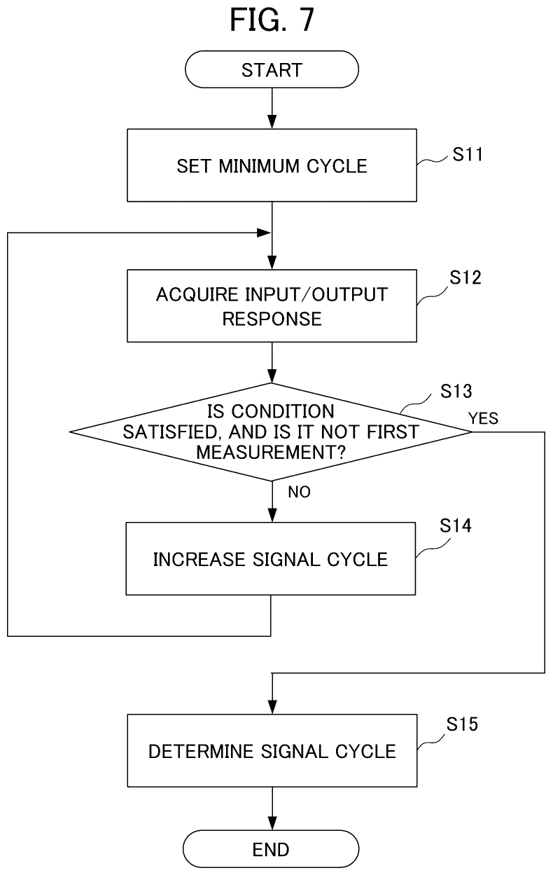

Adjustment operation for the cycle in the motor control device will now be described herein. Adjustment operation for the amplitude in the motor control device is similar or identical to the adjustment operation for the cycle in the motor control device, which will be described below, when the cycle serving as a target of adjustment is replaced with the amplitude, and its description is omitted. FIG. 7 is a flowchart illustrating the adjustment operation for the cycle in the motor control device. In below description, it is described that the signal-changing unit 17 first starts with and increases a smaller amplitude in a step-wise manner when the cycle of a command signal is to be changed.

In Step S11 illustrated in FIG. 7, the signal-changing unit 17 sets a minimum cycle. As the signal-changing unit 17 sets the minimum cycle and outputs the minimum cycle to the signal input unit 11, the signal input unit 11 inputs a command signal to the adder 125 in the motor control unit 12. The motor control unit 12 generates a speed command based on a position command outputted from the CNC machine, for example, generates a torque command based on a speed error that is a difference between the speed command and speed feedback, and outputs the torque command to the input/output response calculation unit 13. The adder 125 adds the command signal and the torque command to each other, and outputs the added command signal and torque command to the electric current control unit 126.

In Step S12, the input/output response calculation unit 13 uses the command signal and the torque command to acquire an input/output response. The comparison unit 16 compares the input/output response calculated by the input/output response calculation unit 13 with an input/output response stored in the input/output response storage unit 14 to acquire a resonance movement amount RM1.

In Step S13, the signal-changing unit 17 determines, when no input/output response is stored in the input/output response storage unit 14, and no resonance movement amount RM1 is acquired in the comparison unit 16, the input/output response acquired by the input/output response calculation unit 13 as a first measurement (when “NO”), and instructs the signal input unit 11 to increase the cycle of a command signal. Furthermore, the signal-changing unit 17 instructs, based on a result of the comparison, the signal input unit 11 to increase the cycle of a command signal when conditions set by the condition-setting unit 15 are not satisfied (when “NO”), that is, when the resonance movement amount RM1 is larger than the resonance movement amount RM2, for example. In Step S13, the signal-changing unit 17 proceeds to Step S15 when the input/output response acquired by the input/output response calculation unit 13 is not the first measurement, and the conditions set by the condition-setting unit 15 are satisfied (when “YES”) , that is, the resonance movement amount RM1 is 0 or equal to or below the resonance movement amount RM2, for example.

In Step S14, the signal input unit 11 increases, when an instruction of increasing the cycle of a command signal is received from the signal-changing unit 17, the cycle of a command signal, and outputs a command signal for which the cycle has been increased.

In Step S15, the signal-changing unit 17 determines the cycle of a command signal of the signal input unit 11 when the resonance movement amount RM1 is 0 or equal to or below the resonance movement amount RM2.

When the characteristics of a command signal are to be changed, both the cycle and amplitude of a command signal may be changed. In that case, it is possible to apply a method of, after the cycle and amplitude of a command signal are sequentially changed and determined, that is, the cycle of a command signal is changed and the cycle is determined, for example, changing the cycle of a command signal and determining the cycle.

In the present embodiment, as described above, it is possible to set the cycle or amplitude of a command signal, with which there is no or a small movement of resonance.

### Modification Example

In the embodiment described above, the example where an output from the motor control unit 12 is a torque command has been described. The present modification example describes a case where the motor control unit 12 is replaced with a motor control unit 12A, and an output from the motor control unit 12A is speed feedback (a detection speed). A configuration of the motor control device, according to the present modification example, is identical to the configuration of the motor control device 10 illustrated in FIG. 1, except that the motor control unit 12 has been replaced with the motor control unit 12A.

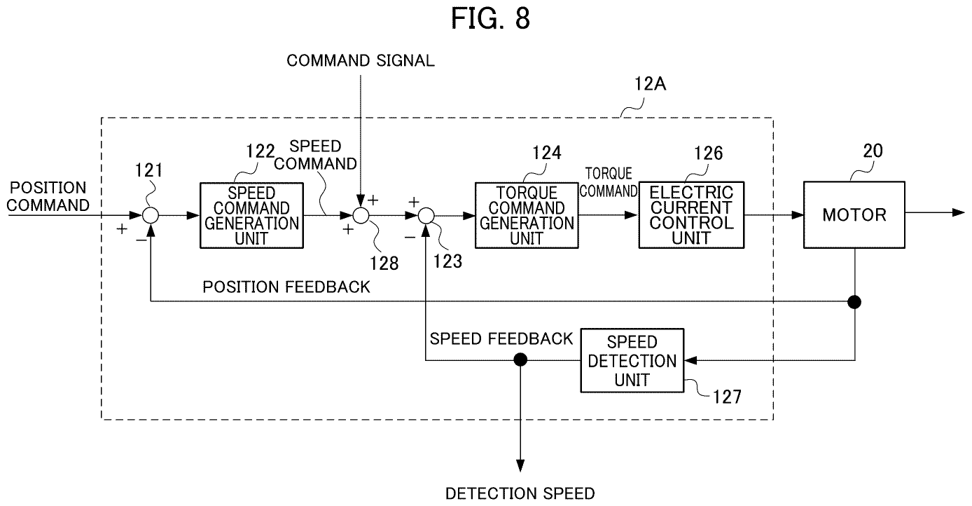

Components of the motor control unit 12A will now be described herein. FIG. 8 is a block diagram illustrating a configuration of the motor control unit 12A. In FIG. 8, like reference numerals designate identical components to the components of the motor control unit 12 illustrated in FIG. 2.

In the motor control unit 12A, as illustrated in FIG. 8, an adder 128 is added, and the adder 125 is removed, compared with the motor control unit 12 illustrated in FIG. 2. In below description, operation of the motor control unit 12A, which is different from the operation of the motor control unit 12 illustrated in FIG. 2, will now be described, and description of common operation will be omitted.

In the motor control unit 12A, a command signal is inputted to the adder 128, and the adder 128 adds a speed command outputted from the speed command generation unit 122 and the command signal to each other, and outputs the added speed command and command signal to the subtracter 123. The subtracter 123 acquires a difference between the speed command to which the command signal is added and a detection speed serving as speed feedback, and outputs the acquired difference to the torque command generation unit 124 as a speed error.

A rotation angle position of the motor 20 is detected by the rotary encoder (not illustrated) provided to the motor 20, and a position detection value is outputted to the subtracter 121 as position feedback. The position detection value is converted by the speed detection unit 127 into a speed, and a speed detection value is inputted to the subtracter 123 and the input/output response calculation unit 13 as speed feedback.

It is possible to apply the motor control device according to the embodiment and the modification example described above to Patent Document 1 and Patent Document 2 where, when a gain or a filter is to be adjusted, an input/output response such as a frequency response is acquired and parameters for the gain or the filter are changed based on the input/output response. That is, the motor control device according to the embodiment and the modification example makes it possible to use a command signal for which the cycle or amplitude is determined, acquire a frequency response, and change parameters for a gain or a filter from its input/output response to adjust the parameters.

It is possible to achieve the components included in the motor control device 10 according to the embodiment and the modification example described above through hardware, software, or a combination of the hardware and the software. Note herein that achievement through software means achievement when a computer reads and executes programs. To achieve the components included in the motor control device 10 through software or a combination including the software, the motor control device 10 includes an arithmetic processing device such as a central processing unit (CPU). The arithmetic processing device functions as an execution unit. Furthermore, the motor control device 10 further includes an auxiliary storage device such as a hard disk drive (HDD) that stores programs for various types of control, including application software or an operating system (OS), and a main storage device such as a random access memory (RAM) that stores data that the arithmetic processing device temporarily requires to execute the programs.

Then, in the motor control device 10, the arithmetic processing device reads the application software or the OS from the auxiliary storage device, deploys the read application software or OS into the main storage device, and performs arithmetic processing based on the application software or OS. Furthermore, based on a result of the arithmetic processing, various types of hardware that the motor control device includes are controlled. Thereby, the functional blocks according to the present embodiment are achieved.

It is possible to achieve the components included in the motor control device 10 through hardware including electronic circuits, for example. When the motor control device is configured through hardware, it is possible to configure some or all of the functions of the components included in the motor control device with, for example, an integrated circuit (IC) such as an application specific integrated circuit (ASIC), a gate array, a field programmable gate array (FPGA), or a complex programmable logic device (CPLD).

It is possible to use a non-transitory computer readable medium that varies in type to store the programs, and to supply the programs to a computer. Examples of the non-transitory computer readable medium include tangible storage media that vary in type. Examples of the non-transitory computer readable medium include a magnetic recording medium (for example, a hard disk drive), a magneto-optical recording medium (for example, a magneto-optical disc), a compact disc read only memory (CD-ROM), a compact disc-recordable (CD-R), a compact disc-rewritable (CD-R/W), a semiconductor memory (for example, a mask ROM, a programmable ROM (PROM), an erasable PROM (EPROM), a flash ROM, and a random access memory (RAM) ). Furthermore, the programs may be supplied to the computer via a transitory computer readable medium that varies in type.

Effects of the embodiment and the modification example described above are to make it possible to determine the characteristics of, that is, at least either the cycle or amplitude of a command signal such as a torque command through automatic adjustment.

Although the present disclosure has been described above, the present disclosure is not limited to the embodiment and the modification example described above. It is possible to variously make additions, replacements, modifications, and partial deletions, for example, in the embodiment and the modification example without departing from the scope of the present disclosure or without departing from the scope of the present disclosure, which is derived from the contents described in Claims and their equivalents. Furthermore, it is also possible to implement the embodiment and the modification example in a combined manner. For example, in the embodiment described above, the order of operations and the order of steps in the processing are indicated as mere examples, and the present disclosure is not limited to the embodiment.

Regarding the embodiment and the modification example described above, notes described below are further disclosed.

### Supplementary Note 1

A motor control device (10) includes: a motor control unit (12, 12A) that controls a motor (20) ; a signal input unit (11) that inputs a command signal to the motor control unit; an input/output response calculation unit (13) that calculates an input/output response including a gain of an input/output signal of the motor control unit from an output from the motor control unit when the command signal is inputted to the motor control unit; an input/output response storage unit (14) that stores the input/output response calculated by the input/output response calculation unit; a condition-setting unit (15) that sets conditions for determining whether or not characteristics of the command signal are to be changed; a comparison unit (16) that compares the input/output response calculated by the input/output response calculation unit with the input/output response stored in the input/output response storage unit; and a signal-changing unit (17) that changes the characteristics of the command signal when a result of the comparison by the comparison unit does not satisfy the conditions set by the condition-setting unit.

### Supplementary Note 2

In the motor control device as described in Supplementary Note 1, the motor control unit (12) includes: a speed command creation unit (121) that creates a speed command for the motor (20); and a torque command creation unit (123) that creates a torque command for the motor based on the speed command, wherein the command signal is inputted to the motor control unit and added to the torque command, and the output from the motor control unit is the torque command.

### Supplementary Note 3

In the motor control device as described in Supplementary Note 1, the motor control unit (12A) includes: a speed command creation unit (121) that creates a speed command for the motor (20); a speed detection unit (128) that detects a speed of the motor and provides the detected speed to the torque command creation unit as feedback; and a torque command creation unit (123) that creates a torque command for driving the motor based on a difference between a signal, in which the command signal has been added to the speed command, and the detected speed, wherein the command signal is inputted to the motor control unit and added to the speed command, and the output from the motor control unit is the detected speed.

### Supplementary Note 4

In the motor control device as described in Supplementary Note 1, the signal-changing unit (17) changes a cycle of changing a frequency of the command signal.

### Supplementary Note 5

In the motor control device as described in Supplementary Note 1, the signal-changing unit (17) changes an amplitude of the command signal.

### Supplementary Note 6

In the motor control device as described in Supplementary Note 1, the condition-setting unit (15) sets conditions related to a frequency movement of resonance between two input/output responses calculated by the input/output response calculation unit (13) before and after the characteristics of the command signal have been changed by the signal-changing unit (17).

### Supplementary Note 7

In the motor control device as described in Supplementary Note 1, the condition-setting unit (15) includes a storage unit that stores the conditions to be set.

### Supplementary Note 8

In the motor control device as described in Supplementary Note 1, the condition-setting unit (15) sets, as a condition, that resonance of the input/output response calculated by the input/output response calculation unit (13) has not yet moved from resonance of the input/output response before a change for the command signal stored in the input/output response storage unit (14).

### Supplementary Note 9

In the motor control device as described in Supplementary Note 1, the condition-setting unit (15) sets, as a condition, that a frequency to which resonance of the input/output response calculated by the input/output response calculation unit has moved from resonance of the input/output response before a change for the command signal stored in the input/output response storage unit is equal to or below a value set beforehand.

### Supplementary Note 10

In the motor control device as described in Supplementary Note 1, the signal-changing unit (17) causes, when a result of comparison by the comparison unit (16) is determined to not satisfy the conditions set by the condition-setting unit (15) while the signal input unit (11) is inputting the command signal, the signal input unit to stop inputting of the command signal in progress, and changes the characteristics of the command signal.

### Supplementary Note 11

In the motor control device as described in Supplementary Note 1, when the motor control unit (12, 12A) is operated based on the changed command signal, if a maximum value of the calculated input/output response is equal to or above a set value, if a speed or torque equal to or above a set value is observed, or if abnormal noise equal to or above a set value is detected, the signal-changing unit (17) returns the command signal to the value before being changed, reduces a change width for the characteristics of the command signal, and changes the command signal again.

### Supplementary Note 12

In the motor control device as described in Supplementary Note 1, the signal-changing unit (17) changes the characteristics of the command signal by a set constant value or a constant magnification or changes a value or a ratio of a change width as the characteristics of the command signal are changed.

### Supplementary Note 13

In the motor control device as described in Supplementary Note 1, the signal-changing unit (17) determines whether or not a change width for the command signal is to be changed by a set value or ratio based on whether or not at least either an average value or a maximum value of the input/output response calculated by the input/output response calculation unit (13) exceeds a set value.

### Supplementary Note 14

In the motor control device as described in Supplementary Note 1, the signal-changing unit (17) determines whether or not a change width for the command signal is to be changed by a set value or ratio based on whether or not at least either an average value or a maximum value of a speed detection value of the motor control unit (12, 12A) exceeds a set value.

### Supplementary Note 15

In the motor control device as described in Supplementary Note 1, the input/output response calculation unit (13) calculates a frequency response for estimating a frequency response including a gain and a phase of the input/output signal of the motor control unit (12, 12A).

### EXPLANATION OF REFERENCE NUMERALS

10 Motor control device
11 Signal input unit
12, 12A Motor control unit
13 Input/output response calculation unit
14 Input/output response storage unit
15 Condition-setting unit
16 Comparison unit
17 Signal-changing unit
20 Motor

1. A motor control device comprising:
a motor control unit that controls a motor;
a signal input unit that inputs a command signal to the motor control unit;
an input/output response calculation unit that calculates an input/output response including a gain of an input/output signal of the motor control unit from an output from the motor control unit when the command signal is inputted to the motor control unit;
an input/output response storage unit that stores the input/output response calculated by the input/output response calculation unit;
a condition-setting unit that sets conditions for determining whether or not characteristics of the command signal are to be changed;
a comparison unit that compares the input/output response calculated by the input/output response calculation unit with the input/output response stored in the input/output response storage unit; and
a signal-changing unit that changes the characteristics of the command signal when a result of the comparison by the comparison unit does not satisfy the conditions set by the condition-setting unit.

2. The motor control device according to claim 1, wherein the motor control unit includes:
a speed command creation unit that creates a speed command for the motor; and
a torque command creation unit that creates a torque command for the motor based on the speed command,
wherein the command signal is inputted to the motor control unit and added to the torque command, and the output from the motor control unit is the torque command.

3. The motor control device according to claim 1, wherein the motor control unit includes:
a speed command creation unit that creates a speed command for the motor;
a speed detection unit that detects a speed of the motor and provides the detected speed to the torque command creation unit as feedback; and
a torque command creation unit that creates a torque command for driving the motor based on a difference between a signal, in which the command signal has been added to the speed command, and the detected speed,
wherein the command signal is inputted to the motor control unit and added to the speed command, and the output from the motor control unit is the detected speed.

4. The motor control device according to claim 1, wherein the signal-changing unit changes a cycle of changing a frequency of the command signal.

5. The motor control device according to claim 1, wherein the signal-changing unit changes an amplitude of the command signal.

6. The motor control device according to claim 1, wherein the condition-setting unit sets conditions related to a frequency movement of resonance between two input/output responses calculated by the input/output response calculation unit before and after the characteristics of the command signal have been changed by the signal-changing unit.

7. The motor control device according to claim 1, wherein the condition-setting unit includes a storage unit that stores the conditions to be set.

8. The motor control device according to claim 1, wherein the condition-setting unit sets, as a condition, that resonance of the input/output response calculated by the input/output response calculation unit has not yet moved from resonance of the input/output response before a change for the command signal stored in the input/output response storage unit.

9. The motor control device according to claim 1, wherein the condition-setting unit sets, as a condition, that a frequency to which resonance of the input/output response calculated by the input/output response calculation unit has moved from resonance of the input/output response before a change for the command signal stored in the input/output response storage unit is equal to or below a value set beforehand.

10. The motor control device according to claim 1, wherein the signal-changing unit causes, when a result of comparison by the comparison unit is determined to not satisfy the conditions set by the condition-setting unit while the signal input unit is inputting the command signal, the signal input unit to stop inputting of the command signal in progress, and changes the characteristics of the command signal.

11. The motor control device according to claim 1, wherein when the motor control unit is operated based on the changed command signal, if a maximum value of the calculated input/output response is equal to or above a set value, if a speed or torque equal to or above a set value is observed, or if abnormal noise equal to or above a set value is detected, the signal-changing unit returns the command signal to the value before being changed, reduces a change width for the characteristics of the command signal, and changes the command signal again.

12. The motor control device according to claim 1, wherein the signal-changing unit changes the characteristics of the command signal by a set constant value or a constant magnification or changes a value or a ratio of a change width as the characteristics of the command signal are changed.

13. The motor control device according to claim 1, wherein the signal-changing unit determines whether or not a change width for the command signal is to be changed by a set value or ratio based on whether or not at least either an average value or a maximum value of the input/output response calculated by the input/output response calculation unit exceeds a set value.

14. The motor control device according to claim 1, wherein the signal-changing unit determines whether or not a change width for the command signal is to be changed by a set value or ratio based on whether or not at least either an average value or a maximum value of a speed detection value of the motor control unit exceeds a set value.

15. The motor control device according to claim 1, wherein the input/output response calculation unit calculates a frequency response including a gain and a phase of the input/output signal of the motor control unit.
